(19) United States
(12) Patent Application Publication
(10) Pub. No.: US 2022/0224875 A1
(43) Pub. Date: Jul. 14, 2022

(54) SYSTEMS AND METHODS FOR CAPTURING A THREE-DIMENSIONAL IMAGE

(71) Applicant: Snap 'N Fit, LLC d/b/a StyleScan, Wilmington, DE (US)

(72) Inventors: Hein Hundal, Port Matilda, PA (US); Rob Reitzen, Los Angeles, CA (US); Larissa Posner, New York, NY (US); Andrew Raffensperger, New Holland, PA (US)

(21) Appl. No.: 17/575,277

(22) Filed: Jan. 13, 2022

Related U.S. Application Data
(60) Provisional application No. 63/136,899, filed on Jan. 13, 2021.

(51) Int. Cl. H04N 13/246; H04N 13/282; H04N 13/296

(52) U.S. Cl. CPC H04N 13/246; H04N 2013/0081; H04N 13/296; H04N 13/282

(57) ABSTRACT

A method may include positioning a plurality of devices around a calibration subject; calculating, for each secondary device of the at least one secondary devices, a time offset between the master device and the secondary device; capturing, on each device of the plurality of devices, a first three-dimensional depth frame of the calibration subject; calculating a plurality of depths based on the first three-dimensional depth frames; capturing, on each device of the plurality of devices, a second three-dimensional depth frame of a photography subject; and assembling, based on the second three-dimensional depth frames, a three-dimensional data representation of the photography subject.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This nonprovisional patent application claims priority to U.S. Provisional Patent Application No. 63/136,899, entitled “Systems and Methods for Capturing a Three-dimensional Image,” filed on Jan. 13, 2021, which is pending, the entirety of which is incorporated by reference.

### STATEMENT REGARDING

### FEDERALLY SPONSORED RESEARCH OR DEVELOPMENT

Not Applicable

### BACKGROUND OF THE INVENTION

The present disclosure relates generally to three-dimensional imagery and more particularly relates to systems and methods for capturing a three-dimensional image.

One conventional system of generating three-dimensional imagery includes a single, depth-calculating camera moving to multiple positions around the photography subject, the camera capturing one or more images at each position, and later compiling the multiple captured images into one three-dimensional image. However, in such a system, the photography subject cannot move or else the multiple captured images will not compile correctly. A second conventional system of generating three-dimensional images includes positioning multiple non-depth-calculating cameras around the photography subject, capturing two-dimensional images with the multiple cameras, and compiling the captured images into the three-dimensional image. However, the positions of the cameras in relation to the photography subject must be known beforehand.

Thus, what is needed are improvements to systems and methods for capturing a three-dimensional image.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the disclosure is a method. The method may include positioning a plurality of devices around a calibration subject. The plurality of devices may include a master device and at least one secondary device. The method may include calculating, for each secondary device of the at least one secondary devices, a time offset between the master device and the secondary device. The method may include capturing, on each device of the plurality of devices, a first three-dimensional depth frame of the calibration subject. The plurality of devices may capture the first three-dimensional depth frames simultaneously based on the time offsets. The method may include calculating a plurality of depths based on the first three-dimensional depth frames. The method may include capturing, on each device of the plurality of devices, a second three-dimensional depth frame of a photography subject. The plurality of devices may capture the second three-dimensional depth frames simultaneously based on the time offsets. The method may include assembling, based on the second three-dimensional depth frames, a three-dimensional data representation of the photography subject.

Another aspect of the disclosure is an apparatus. The apparatus may include a camera. The apparatus may include a processor. The apparatus may include a computer-readable storage medium storing a software application thereon. In response to the processor executing the software application, the apparatus may be configured to send a timestamp request to a second apparatus at a first time; receive a response from the second apparatus, the response including a second time, and the response arriving at the apparatus at a third time; calculate a time offset based on the first time, the second time, or the third time; send a capture request to the second apparatus, the capture request including a command for the second apparatus to capture a first three-dimensional depth frame using the camera of the second device at a fourth time that accounts for the time offset; and capture, at the same time as the capturing of the first three-dimensional depth frame by the second device, a second three-dimensional depth frame using the camera of the device.

Another aspect of the disclosure may include a system. The system may include a plurality of devices. The plurality of devices may include a master device and one or more secondary devices. The system may include a calibration subject and a photography subject. The system may include a computing device. The master device may be operable to calculate, for each of the one or more secondary devices, a time offset between the master device and the secondary device. The master device and the one or more secondary devices may each be operable to simultaneously capture a first three-dimensional depth frame of the calibration subject at a first time. The first time may be based on the time offsets. The master device and the one or more secondary devices may each be operable to simultaneously capture a second three-dimensional depth frame of the photography subject at a second time. The second time may be based on the time offsets. The computing device may be operable to assemble, based on the second three-dimensional depth frames, a three-dimensional data representation of the photography subject.

Numerous other objects, advantages and features of the present disclosure will be readily apparent to those of skill in the art upon a review of the following drawings and description of the embodiments.

### BRIEF DESCRIPTION OF THE DRAWINGS

FIG. 1A is a schematic block diagram illustrating one embodiment of a system for capturing a three-dimensional image.

FIG. 1B is a schematic block diagram illustrating one embodiment of a system for capturing a three-dimensional image.

FIG. 2 is a schematic block diagram of the device from FIG. 1.

FIG. 3 is a flowchart diagram illustrating one embodiment of a method for capturing a three-dimensional image using components from the system of FIG. 1.

FIG. 4 is an action flowchart diagram illustrating example interactions between the master device and a secondary device of FIG. 1.

FIG. 5 is a table illustrating clock times of the master device and the secondary device of FIG. 4.

FIG. 6 is an action flowchart diagram illustrating an example interaction between the master device and a secondary device of FIG. 1.

FIG. 7 is a perspective view illustrating a plurality of points and estimated distances to those points from the device of FIG. 2.

### DETAILED DESCRIPTION

While the makings and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing. A person of skill in the art will recognize that the apparatus can assume different orientations when in use.

Reference throughout this specification to “one embodiment,” “an embodiment,” “another embodiment,” or similar language means that a particular feature, structure, or characteristic described in connection with the embodiment is included in at least one embodiment. Thus, appearances of the phrases “in one embodiment,” “in an embodiment,” “in some embodiments,” and similar language throughout this specification may, but do not necessarily, all refer to the same embodiment, but mean “one or more but not necessarily all embodiments” unless expressly specified otherwise.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. As used herein, the term “a,” “an,” or “the” means “one or more” unless otherwise specified. The term “or” means “and/or” unless otherwise specified.

Multiple elements of the same or a similar type may be referred to as “Elements 102(1)-(n)” where n may include a number. Referring to one of the elements as “Element 102” refers to any single element of the Elements 102(1)-(n). Referring to a “Element 102(1),” “Element 102(2)”, etc. refer to a specific Element 102 of the one or more Elements 102(1)-(n). Additionally, referring to different elements “First Elements 102(1)-(n)” and “Second Elements 104(1)-(n)” does not necessarily mean that there must be the same number of First Elements as Second Elements and is equivalent to “First Elements 102(1)-(n)” and “Second Elements (1)-(m)” where m is a number that may be the same or may be a different number than n.

As used herein, the term “computing device” may include a desktop computer, a laptop computer, a tablet computer, a mobile device such as a mobile phone or a smart phone, a smartwatch, a gaming console, an application server, a database server, or some other type of computing device. A computing device may include a physical computing device or may include a virtual machine (VM) executing on another computing device. A computing device may include a cloud computing system, a distributed computing system, or another type of multi-device system.

As used herein, the term “data network” may include a local area network (LAN), wide area network (WAN), the Internet, or some other network. A data network may include one or more routers, switches, repeaters, hubs, cables, or other data communication components. A data network may include a wired connection or a wireless connection.

As used herein, the terms “determine” or “determining” may include a variety of actions. For example, “determining” may include calculating, computing, processing, deriving, looking up (e.g., looking up in a table, a database or another data structure), ascertaining, or other actions. Also, “determining” may include receiving (e.g., receiving information or data), accessing (e.g., accessing data in a memory, data storage, distributed ledger, or over a network), or other actions. Also, “determining” may include resolving, selecting, choosing, establishing, or other similar actions.

As used herein, the terms “provide” or “providing” may include a variety of actions. For example, “providing” may include generating data, storing data in a location for later retrieval, transmitting data directly to a recipient, transmitting or storing a reference to data, or other actions. “Providing” may also include encoding, decoding, encrypting, decrypting, validating, verifying, or other actions.

As used herein, the term “access,” “accessing”, and other similar terms may include a variety of actions. For example, accessing data may include obtaining the data, examining the data, or retrieving the data. Providing access or providing data access may include providing confidentiality, integrity, or availability regarding the data.

As used herein, the term “message” may include one or more formats for communicating (e.g., transmitting or receiving) information or data. A message may include a machine-readable collection of information such as an Extensible Markup Language (XML) document, fixed-field message, comma-separated message, or another format. A message may, in some implementations, include a signal utilized to transmit one or more representations of information or data.

As used herein, the term “user interface” (also referred to as an interactive user interface, a graphical user interface or a UI), may refer to a computer-provided interface including data fields or other controls for receiving input signals or providing electronic information or for providing information to a user in response to received input signals. A user interface may be implemented, in whole or in part, using technologies such as hyper-text mark-up language (HTML), a programming language, web services, or rich site summary (RSS). In some implementations, a user interface may be included in a stand-alone client software application configured to communicate in accordance with one or more of the aspects described.

As used herein, the term “modify” or “modifying” may include several actions. For example, modifying data may include adding additional data or changing the already-existing data. As used herein, the term “obtain” or “obtaining” may also include several types of action. For example, obtaining data may include receiving data, generating data, designating data as a logical object, or other actions.

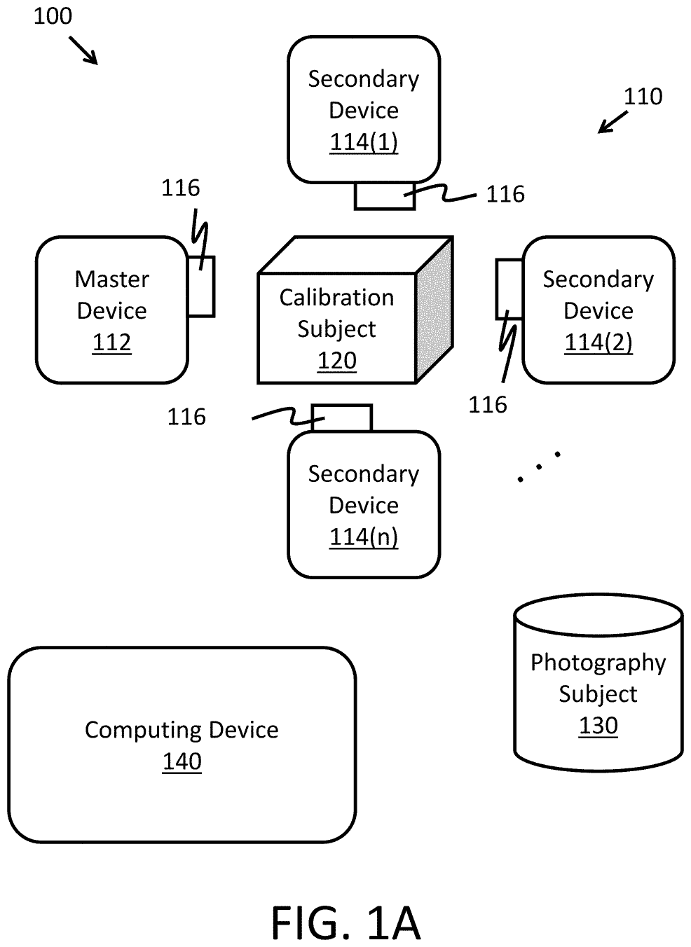

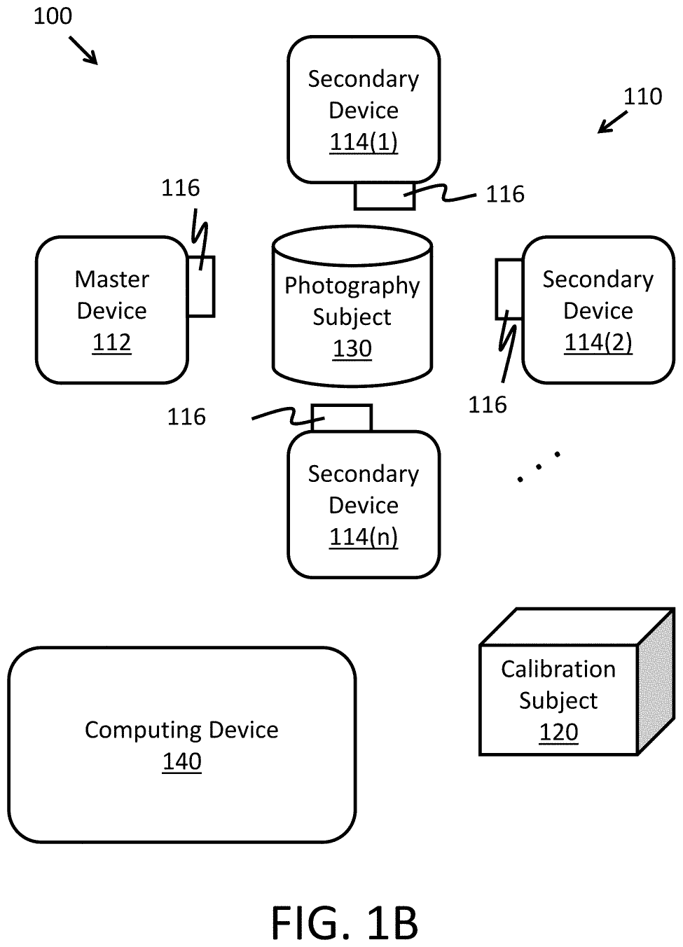

FIG. 1A depicts one embodiment of a system 100 for capturing three-dimensional photographs of a photography subject 130. The system 100 may include a plurality of devices 110. The plurality of devices 110 may include a master device 112. The plurality of devices 110 may include one or more secondary devices 114(1)-(n). Each device of the plurality of devices 110 may include a camera 116. The system 100 may include a calibration subject 120. The system 100 may include a computing device 140.

The master device 112 may be operable to calculate, for each of the one or more secondary devices 114(1)-(n), a time offset between the master device 112 and the secondary device 114. The master device 112 and the one or more secondary devices 114(1)-(n) are each operable to simultaneously capture a first three-dimensional depth frame of the calibration subject 120 at a first time. The first time may be based on the time offsets. Each of the master device 112 and the one or more secondary devices 114(1)-(n) may capture their respective first three-dimensional depth frame using their respective camera 116.

FIG. 1B depicts the system 100. In the system 100 depicted, the photography subject 130 has been placed where the calibration subject 120 had been in FIG. 1A, i.e., in view of the master device 112 and the one or more secondary devices 114(1)-(n). The master device 112 and the one or more secondary devices 114(1)-(n) are each operable to simultaneously capture a second three-dimensional depth frame of the photography subject 130 at a second time. The second time may be based on the time offsets. The each of the master device 112 and the one or more secondary devices 114(1)-(n) may capture their respective second three-dimensional depth frame using their respective camera 116. The computing device 140 may be operable to assemble, based on the second three-dimensional depth frames, a three-dimensional data representation of the photography subject 130.

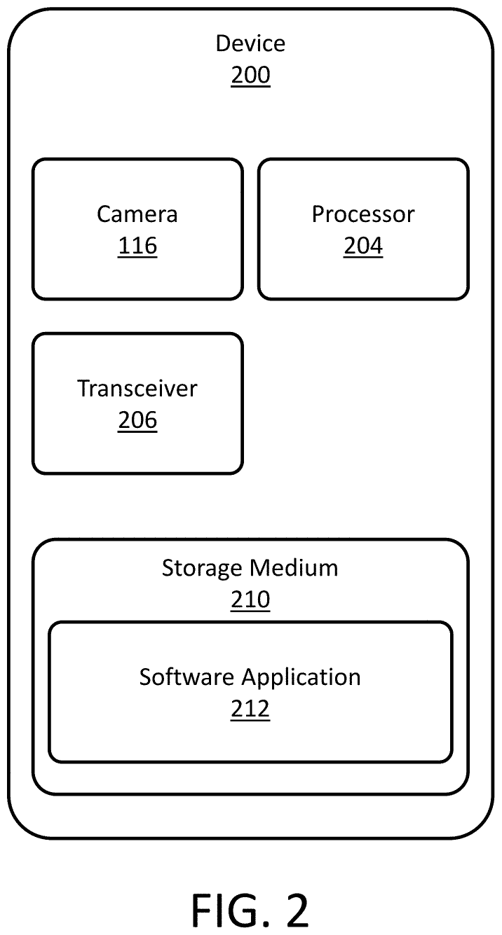

Each of the master device 112 and each of the one or more secondary devices 114(1)-(n) may include exemplary devices 200 as depicted in FIG. 2. Each device 200 may include a device operable to capture an image to be used in three-dimensional imagery. In some embodiments, the device 200 may include a computing device. The device 200 may include a camera 116. The camera 116 may include a digital camera, a phone camera, a single- or twin-lens reflex camera, a video camera, or some other type of camera device. The camera 116 may include components operable to capture an image. The components may include lenses, mirrors shutters, semiconductors, or other camera components. The camera 116 may include distance-sensing components. The distance-sensing components may sense the distance from the camera 116 to an object. The distance-sensing components may include infrared emitters, lenses, or other distance-sensing components.

Each device 200 may include a processor 204. The processor 204 may process data, computer-readable instructions, or other information on the device 200. The processor 204 may include a computer processor, a central processing unit (CPU), a microprocessor, an image processor, a multi-core processor, or some other type of processor. The processor 204 may cause other components of the device 200 to perform certain functions.

Each device 200 may include a transceiver 206. The transceiver 206 may be operable to receive data from another device. The transceiver 206 may be operable to transmit data to another device. The transceiver 206 may include a wired or a wireless transceiver. The transceiver 206 may include a Bluetooth transceiver, a Wi-Fi transceiver, a cellular data transceiver, a near-field communication (NFC) transceiver, or some other wireless transceiver. In some embodiments, the transceiver 206 may include a universal serial bus (USB) port, a Lightning connector, or some other wired connection component.

The device 200 may include a storage medium 210. The storage medium may be operable to store data. The storage medium 210 may include a non-transitory, computer-readable storage medium. The storage medium 210 may include volatile or non-volatile memory. The storage medium 210 may include random access memory (RAM), flash memory, a hard disk drive (HDD), or other storage media. The storage medium 210 may include a software application 212. The software application 212 may be operable to capture an image (using the camera 116), process the image, and transmit the image to another device. The software application 212 may include software that includes one or more computer-readable instructions. The computer-readable instructions may be executable by the processor 204.

In one or more embodiments, the software application 212 of a device of the plurality of devices 110 may be operable to establish a data connection between the device and another device of the plurality of devices 110. Establishing a data connection may include Bluetooth pairing, joining a Bluetooth network, joining a Wi-Fi network, or another function that establishes data communication between devices. The software application 212 may be operable to cause a device of the plurality of devices 110 to act as either the master device 112 or as a secondary device 114. In some embodiments, the software applications 212 of the plurality of devices 110 may coordinate to randomly select one of the devices to act as the master device 112. In other embodiments, a user may interact with a user interface of the software application 212 of one of the plurality of devices 110 to designate that device as the master device 112. The remaining devices may then be designated as the one or more secondary devices 114(1)-(n).

The software application 212 of the master device 112 may be operable to calculate a time offset between the master device 112 and each of the one or more secondary devices 114(1)-(n). The software application 212 of each of the plurality of devices 110 may be operable to capture, using the camera 116 of the device, a three-dimensional depth frame of a subject. The subject may include the calibration subject 120 or the photography subject 130. The software application 212 of each of the plurality of devices 110 may be operable to capture the three-dimensional depth frames simultaneously based on the time offsets.

In one embodiment, the software application 212 of each of the plurality of devices 110 may be operable to send the three-dimensional depth frame to the computing device 140. In another embodiment, the software application 212 of each of the one or more secondary devices 114(1)-(n) may send the three-dimensional depth frame to the master device 212. The software application 212 of the master device 112 may assemble, based on the received three-dimensional depth frames of the photography subject 130, a three-dimensional data representation of the photography subject 130, or the software application 212 of the master device 112 may send the three-dimensional depth frames to the computing device 140, and the computing device 140 may perform the assembly of the three-dimensional data representation of the photography subject 130. The software application 212 may perform other functions.

In one or more embodiments, the processor 204, storage medium 210, or software application 212 may be located externally from the device 200. For example, the processor 204, storage medium 210, or software application 212 may be located on the computing device 140 or on some other computing device. Thus, in some embodiments, the device 200 may include primarily image capture functionality, and computing or other functionality may occur on some other device.

In some embodiments, the calibration subject 120 may include a first object. The first object may include an object whose dimensions are known by one of the plurality of devices 110, the computing device 140, a user of the system 100, or something else. The calibration subject 120 may include a ruler, a piece of paper, a wall, a floor, or some other object. The photography subject 130 may include a second object. The second object may include an object whose dimensions are not known. The photography subject 130 may include clothing, clothing on a model or mannequin, a commercial product, or some other object.

The computing device 140 may include a smartphone, a tablet computer, a laptop computer, a desktop computer, an application server, a database server, a cloud computing cluster, or some other type of computing device. The computing device 140 may include a processor, storage media, or one or more software applications. The computing device 140 may be operable to receive three-dimensional depth frames from the plurality of devices 110 and assemble the depth frames into data representing a three-dimensional image.

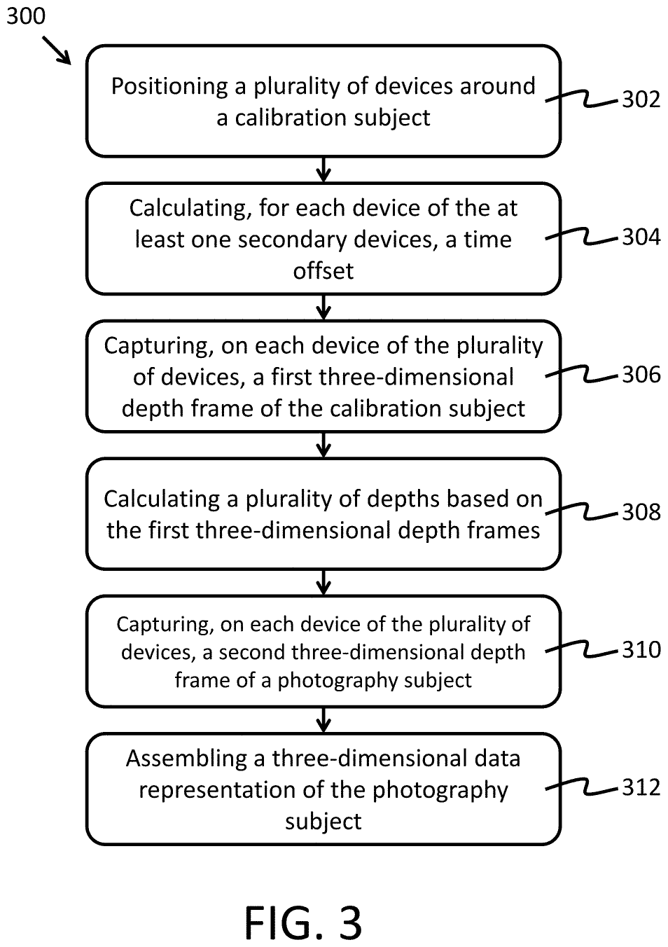

FIG. 3 depicts one embodiment of a method 300 for generating a three-dimensional image. The method 300 may include positioning 302 a plurality of devices 110 around the calibration subject 120. The plurality of devices 110 may include the master device 112 and one or more secondary devices 114(1)-(n). The method 300 may include calculating 304, for each of the one or more secondary devices 114(1)-(n), a time offset between the master device 112 and the secondary device 114. The method 300 may include capturing 306, on each of the plurality of devices 110, a first three-dimensional depth frame of the calibration subject 120. The plurality of devices 110 may capture the first three-dimensional depth frames simultaneously based on the time offsets.

The method 300 may include calculating 308 a plurality of depths. The plurality of depths may be based on the first three-dimensional depth frames. The method 300 may include capturing 310, on each of the plurality of devices 110, a second three-dimensional depth frame of the photography subject 130. The plurality of devices 110 may capture the second three-dimensional depth frames simultaneously based on the time offsets. The method 300 may include assembling 312, based on the second three-dimensional depth frames, a three-dimensional data representation of the photography subject 130.

In one embodiment, positioning 302 the plurality of devices 110 around the calibration subject 120 may include positioning the plurality of devices 110 such that the cameras 116 face the calibration subject 120. Positioning 302 the plurality of devices 110 may include the plurality of devices 110 being at the same height from the ground as each other or different heights, being generally evenly or symmetrically spaced around the calibration subject 120 or being variably spaced, or being at the same height as the calibration subject 120 or at least one of the plurality of devices 110 being at a different height than the calibration subject 120. Positioning 302 the plurality of devices 110 may include disposing at least one of the plurality of devices 110 on a tripod, crane, wire, arm, or other height- or position-adjusting tool. In some embodiments, positioning 302 the plurality of devices 110 may include the plurality of devices 110 being arranged around the calibration subject 120 such that each portion (or at least, each portion of the calibration subject 120 used for calibration purposes) of the surface of the calibration subject 120 is viewable by at least one of the plurality of cameras 116.

In one embodiment, calculating 304 the time offset may include calculating a time difference between a clock of the master device 112 and a secondary device 114. The time difference may be expressed as a time interval that the secondary device's 114 clock is ahead or behind the master device's 112. For example, the time difference may be 250 milliseconds (indicating that the secondary device's 114 clock is 250 milliseconds ahead of the master device's 112 clock), −500 milliseconds (indicating that the secondary device's 114 clock is 500 milliseconds behind the master device's 112 clock), 0 milliseconds (indicating that the secondary device's 114 clock and the master device's 112 clock are synchronized), or some other value. The time difference may be expressed in various units (e.g., seconds, milliseconds, microseconds, or some other time unit).

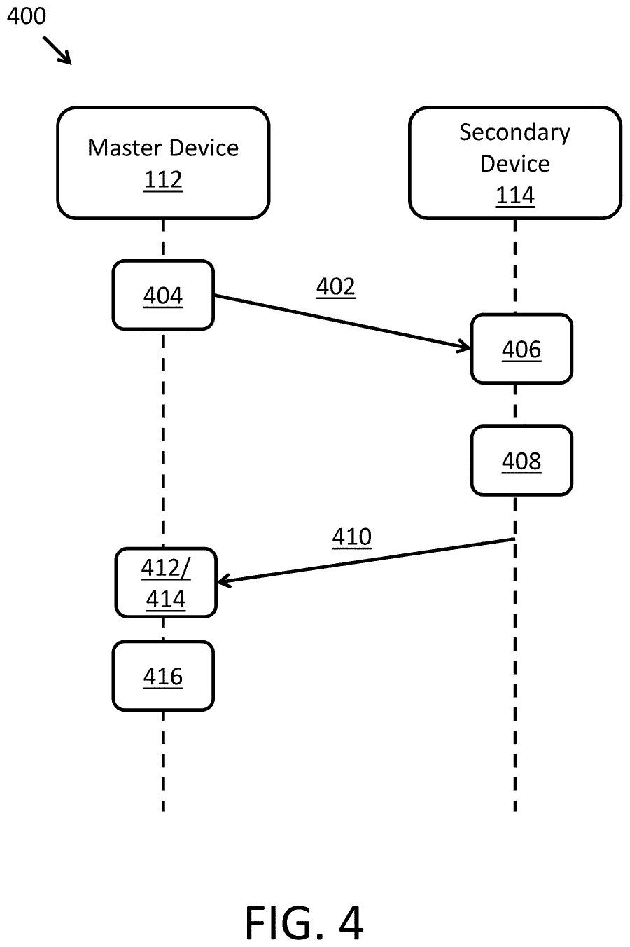

FIG. 4 depicts one embodiment of a flowchart 400 showing how the master device 112 may obtain the time difference between the master device 112 and a secondary device 114. The method 400 may include, at step 402, the master device 112 sending a timestamp request to the secondary device 114 at a first time. At step 404, the master device 112 may store a first timestamp (according to its own clock) corresponding to the first time. At step 406, the secondary device 114 may receive the timestamp request. At step 408, the secondary device 114 may determine a second timestamp (according to its own clock) at which it processed the timestamp request. The second timestamp may correspond to a second time. At step 410, the secondary device 114 may send a response back to the master device 112. The response may include the second timestamp. At step 412, the master device 112 may receive the response from the secondary device 114 at a third time. At step 414, the master device 112 may store a third timestamp (according to its own clock) corresponding to the third time (i.e., the time at which the master device 112 received the response). At step 416, the master device 112 may calculate the time difference using the first timestamp, the second timestamp, and the third timestamp.

In one embodiment, the time difference may be calculated according to the equation

$${T}_{d} = {T}_{s} - \frac{{T}_{t} + {T}_{r}}{2}$$

where T_{d} is the time difference, Tₜ is the first timestamp (i.e., the time the master device 112 sent the timestamp request, according to its own clock), Tₛ is the second timestamp (i.e., the time the secondary device 114 processed the timestamp request, according to its own clock), and Tᵣ is the third timestamp (i.e., the time the master device 112 received the response from the secondary device 114, according to the master device's 112 own clock).

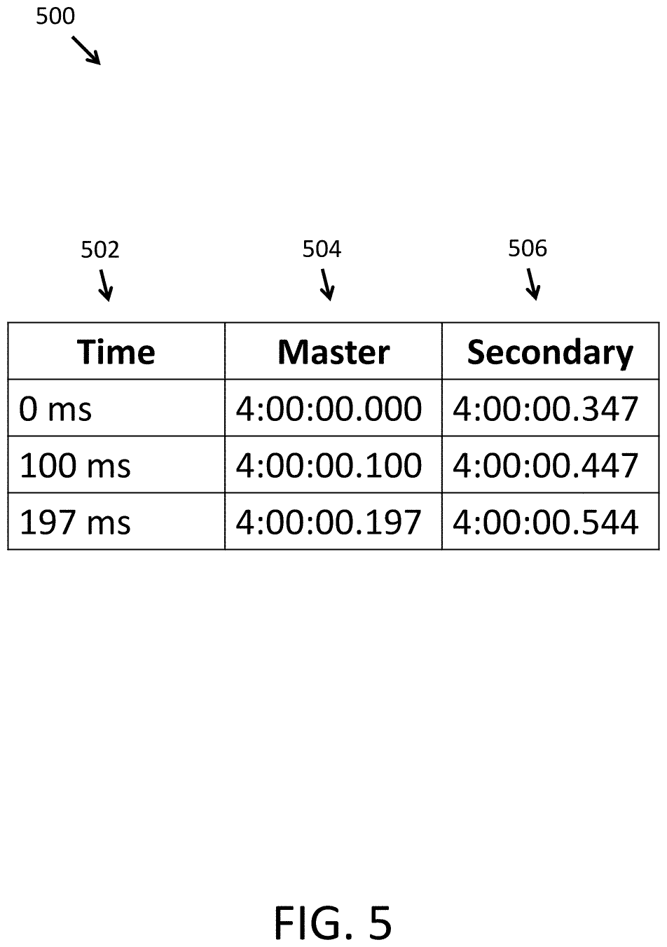

As an example, FIG. 5 depicts a table 500. In the table 500, the first column 502 shows the time elapsed since the start of the example, the second column 504 shows the time according to the master device's 112 clock, and the third column 506 shows the time according to the secondary device's 114 clock. In the example, at time elapsed=0 (i.e., the first row of the table), the clock of the master device 112 may be 4:00:00.000 and the clock of the secondary device 114 may be 4:00:00.347. Thus, the clock of the secondary device 114 is 347 milliseconds ahead of the master device's 112 clock. At 4:00:00.000, the master device 112 may send the timestamp request to the secondary device (step 402). The master device 112 may store 4:00:00.000 as the first timestamp, Tₜ (step 404). The timestamp request may take 100 milliseconds to be received by the secondary device 114. Thus, at time elapsed=100 (i.e., the second row of the table), the secondary device 114 may receive the timestamp request (step 406). The secondary device 114 may process the timestamp request and determine that the second timestamp (according to its own clock), Tₛ, is 4:00:00.447 (step 408). The secondary device 114 may send the response back to the master device 112, and the response may include the second timestamp of 4:00:00.447. The response may take 97 milliseconds to be received by the master device 112. Thus, at time elapsed=197 milliseconds (i.e., the third row of the table), the master device 112 may receive the response (step 412) and determine that the third timestamp, the time the master device 112 received the response (according to its own clock), Tᵣ, is 4:00:00.197 (step 414). The master device 112 may calculate the time difference using the first, second, and third timestamps (step 416). Calculating the time difference may include using the equation above with the first, second, and third timestamps, i.e., T_{d}=4:00:00.447−(4:00:00.000+4:00:00.197)/2=348.5. Thus, the master device 112 calculates that the clock of the secondary device 114 is 348.5 milliseconds ahead of the clock of the master device 112. Thus, the time difference, in this example, may include 348.5 milliseconds.

In some embodiments, the master device 112 may perform actions to obtain a potentially more accurate time difference. For example, the master device 112 may cause the master device 112 and the secondary device 114 to perform the steps 402-416 of the flowchart 400 multiple times to obtain an average (mean, median mode, etc.) time difference.

In other embodiments, the time offset may include a calculated transmission time from the master device 112 to the secondary device 114. The master device 112 may send a request to the secondary device 114. The request may include data requesting that the secondary device 114 send a response to the master device 112. The request may include a ping or other response-requesting type of request. The master device 112 may store a first timestamp that indicates the time at which the master device 112 sent the request. The secondary device 114 may receive the request and send the response. The master device 112 may receive the response. The master device 112 may determine a third timestamp that indicates the time at which the master device 112 received the request. The master device 112 may calculate the calculated transmission time based on the first and third timestamp. In one embodiment, calculating the calculated transmission time may include adding the first and third timestamps together and divide the sum by two. This may calculate a mean transmission time between the master device 112 and the secondary device 114.

The master device 112 may calculate a time offset for each of the one or more secondary devices 114(1)-(n). The master device 112 may store these time offsets and data associating each of them with their respective secondary device 114 in the storage medium 210.

In some embodiments, capturing 306, on each of the plurality of devices 110, the first three-dimensional depth frame of the calibration subject 120 may include the master device 112 sending a capture request to each of the one or more secondary devices 114(1)-(n). In response to receiving a capture request, the receiving secondary device 114 may capture a first three-dimensional depth frame of the calibration subject 120.

In some embodiments, the receiving secondary device 114 may capture the first three-dimensional depth frame at a capture time specified in the capture request. The master device 112 may have previously calculated the time difference between the master device 112 and the secondary device 114. The master device 112 may calculate the capture time by adding or subtracting the time difference to the time at which the master device 112 will capture its first three-dimensional depth frame of the calibration subject 120.

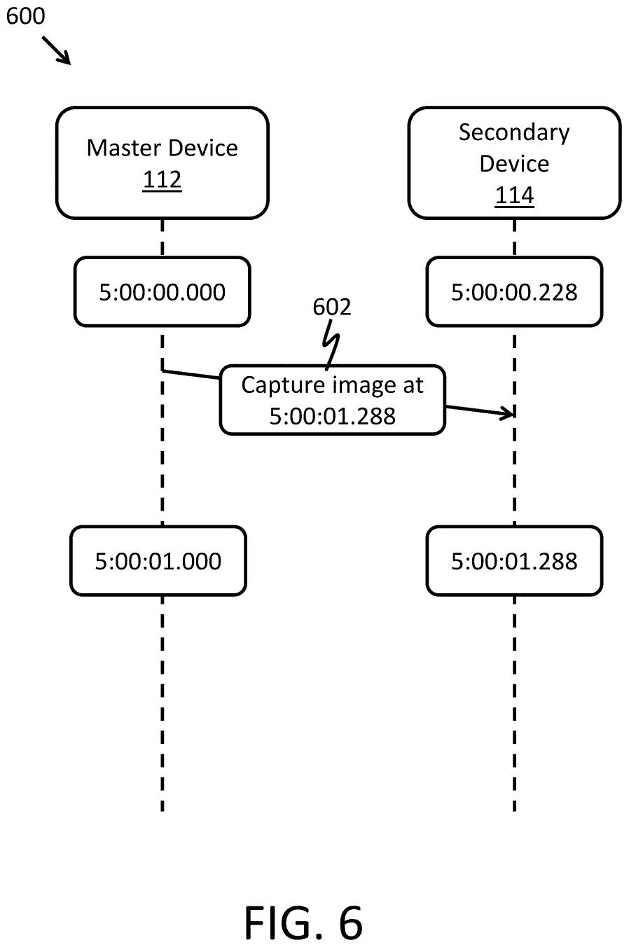

In one example, as depicted in FIG. 6, the master device 112 may have calculated that the time difference between itself and a secondary device 114 is 288 milliseconds (i.e., the clock of the secondary device 114 is 288 milliseconds ahead of the master device's 112 clock). Thus, when the master device's 112 clock is at 5:00:00.000, the secondary device's 114 clock is at 5:00:00.288. Thus, in order for the master device 112 and the secondary device 114 to capture their respective first three-dimensional depth frames simultaneously, the capture time specified in the capture request 602 includes a time 288 milliseconds ahead of the capture time of the master device 112. Therefore, if the master device 112 is to capture its first three-dimensional depth frame at 5:00:01.000, then the capture time in the capture request 602 will be 5:00:001.288.

In other embodiments, the receiving secondary device 114 may capture the first three-dimensional depth frame upon receiving the capture request, and the master device 112 may wait to capture its first three-dimensional depth frame until the predicted time at which the secondary device 114 captures its first three-dimensional depth frame. The master device 112 may wait to capture the first three-dimensional depth frame based on the calculated transmission time between the master device 112 and the secondary device 114. For example, the calculated transmission time may be 359 milliseconds. The master device 112 may send the capture request to the secondary device 114, wait 359 milliseconds, and then capture its first three-dimensional depth frame. In some embodiments, where there are multiple secondary devices 114(1)-(n), the master device 112 may send the capture requests in the order of longest calculated transmission time to shortest calculated transmission time.

In one embodiment, the method 300 may include calculating 308 the plurality of depths based on the first three-dimensional depth frames. A depth of the plurality of depths may include an estimated distance from the camera 116 of each device of the plurality of device 110 to a corresponding point on the calibration subject 120. The camera 116 may use the distance-sensing components of the camera 116 to generate a plurality of points on the calibration subject 120. The camera 116 may use the distance-sensing components to measure the distance from the camera 116 to each of those points. However, the distance measured by the camera 116 may be inaccurate (e.g., due to the limitations of the hardware of the camera 116). A first three-dimensional depth frame may include the plurality of points and the associated measured distances.

Because of the possible inaccuracies of the distances measured by the camera 116, calculating 308 the plurality of depths may include calibrating a measured distance. In some embodiments, in response to the measured distance being less than a predetermined distance threshold, the calibrated depth may be equal to the measured distance. This may be because the hardware of the camera 116 may be more accurate when working with close-up objects than further-away objects. For example, the predetermined distance threshold may be 0.5 meters. Thus, in response to the measured distance being less than 0.5 meters, the calibrated depth may be equal to the measured distance. The predetermined distance threshold may include another suitable value. The predetermined distance threshold may be different for different cameras.

In response to the measured distance being equal to or greater than the predetermined distance threshold, the calibrated depth may be calculated. In one embodiment, the calibrated depth may be calculated according to the equation

D_{c}=α*(D_{d}−p)²+p

where D_{c} is the calibrated depth, α is a depth correction factor, D_{d} is the measured distance (i.e., the distance measured by the camera and which may be inaccurate), and ρ is the predetermined distance threshold.

In some embodiments, calculating the depth correction factor, α, may include using a portion of the known dimensions of the calibration subject 120 in the calculations. Calculating the depth correction factor may include selecting a plurality or patch of points in the first three-dimensional depth frame. Selecting the plurality of points may include selecting 30-100 points or some other range of points. Calculating the depth correction factor may include performing singular value decomposition on the plurality of points to obtain a vector that is approximately normal to the plurality of points. Calculating the depth correction factor may include formulating a polynomial error function based on the vector. Calculating the depth correction factor may include using partial derivatives of the error function with respect to the depth correction factor and gradient descent to determine the value of the depth correction factor that minimizes the polynomial error function. This determined value of the depth correction function may be used as a in the above equation.

In one embodiment, calculating the depth correction factor may include adjusting the angle between two or more surfaces to be closer to or substantially equal to 90 degrees. Calculating the depth correction factor may include minimizing a square of a dot product of a first vector and a second vector. The first vector may include a vector perpendicular to corrected points on the first surface, and the second vector may include a vector perpendicular to corrected points on the second surface. Calculating the depth correction factor may include computing the derivative of the dot product as a function of the depth correction factor. Calculating the depth correction factor may include using the derivative with Newton-Raphson to calculate an optimal depth correction factor. In some embodiments, the two or more surfaces may include (1) a floor surface and a wall surface, (2) a ceiling surface and a wall surface, (3) two wall surfaces, (4) two wall surfaces and a floor surface, (5) two wall surfaces and a ceiling surface, or (6) other surfaces.

Calculating 308 the plurality of depths may include calculating, for each device in the plurality of devices 110, the plurality of depths. In one embodiment, each device of the plurality of devices 110 may calculate 308 its own plurality of depths based on its first three-dimensional depth frame. In other embodiments, the master device 112 may calculate the plurality of depths for each device of the plurality of devices 110 (based on their respective first three-dimensional depth frames), or the computing device 140 may calculate 308 the plurality of depths for the plurality of devices 110.

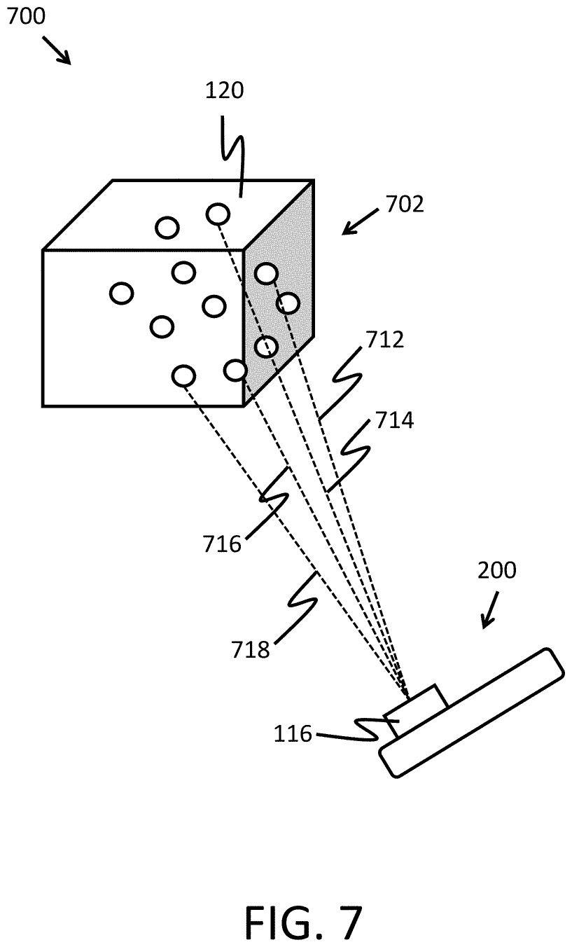

FIG. 7 depicts one embodiment of a system 700. The system 700 may include the device 200. The device 200 may include the camera 116. The device 200 may include the master device 112 or a secondary device 114. The system 700 may include the calibration subject 120. The system 700 may include the plurality of points 702. The plurality of points 702 may be disposed on the calibration subject 120. The camera 116 may use distance-sensing components to project the plurality of points on the calibration subject 120. The camera 116 may use the distance-sensing components to measure distances 712, 714, 716, or 718 from corresponding points of the plurality of points 702 to the camera 116.

In one embodiment, capturing 310 a second three-dimensional depth frame may include capturing 310 a three-dimensional depth frame of the photography subject 130. A user may remove the calibration subject 120 from its position and place the photography subject 130 in a position near the previous position of the calibration subject 120. The user may perform this replacement without the plurality of devices 110 moving.

Capturing 310 the second three-dimensional depth frame of the photography subject 130 may be similar to capturing 306 the first three dimensional depth frame. Capturing 310 the second three-dimensional depth frames may include the plurality of devices 110 capturing their respective three dimensional depth frames simultaneously based on the time offset. Capturing 310 the second three-dimensional depth frame may include calculating a plurality of depths based on the second three-dimensional depth frame. Calculating the plurality of depths based on the second three-dimensional depth frame may include calculating a calibrated depth, which may not include recalculating the depth correction factor, α. The previously calculated depth correction factor may be used.

In one or more embodiments, assembling 312, the three-dimensional data representation of the photography subject 130 may include using an iterative point cloud algorithm, global affine transformation optimization, Poisson surface reconstruction, or voxel mesh generation. The three-dimensional data representation may include a stereolithography (STL) file, a .obj file, a Filmbox (FBX) file, a Collaborative Design Activity (COLLADA) file, a 3ds file, or another three-dimensional image file format. In some embodiments, the three-dimensional data representation may include a 2.5 dimensional mesh of the exterior of the photography subject 130 in the common volume, surface normal, or textures.

In some embodiments, the method 300 may include recalculating the time offsets. Recalculating the time offsets may be in response to a predetermined amount of time elapsing since a previous calculation of the time offsets, in response to a user command received at the user interface of the software application 212, or in response to some other event. In some embodiments, the method 300 may include recalculating 308 the plurality of depths or recalculating the depth correction factor. Recalculating 308 the plurality of depths or recalculating the depth correction factor may be in response to a predetermined amount of time elapsing since a previous recalculation of the plurality of depths or the depth correction factor, in response to a user command received at the user interface of the software application 212, or in response to some other event.

While the making and using of various embodiments of the present disclosure are discussed in detail herein, it should be appreciated that the present disclosure provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and may be covered by the claims.

Furthermore, the described features, structures, or characteristics of the disclosure may be combined in any suitable manner in one or more embodiments. In the description contained herein, numerous specific details are provided, such as examples of programming, software, user selections, hardware, hardware circuits, hardware chips, or the like, to provide understanding of embodiments of the disclosure. One skilled in the relevant art will recognize, however, that the disclosure may be practiced without one or more of the specific details, or with other methods, components, materials, and so forth. In other instances, well-known structures, materials, or operations may not be shown or described in detail to avoid obscuring aspects of the disclosure.

These features and advantages of the embodiments will become more fully apparent from the description and appended claims, or may be learned by the practice of embodiments as set forth herein. As will be appreciated by one skilled in the art, aspects of the present disclosure may be embodied as an apparatus, system, method, computer program product, or the like. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer-readable medium(s) having program code embodied thereon.

In some embodiments, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer-readable medium(s).

In some embodiments, a module may include a smart contract hosted on a blockchain. The functionality of the smart contract may be executed by a node (or peer) of the blockchain network. One or more inputs to the smart contract may be read or detected from one or more transactions stored on or referenced by the blockchain. The smart contract may output data based on the execution of the smart contract as one or more transactions to the blockchain. A smart contract may implement one or more methods or algorithms described herein.

The computer program product may include a computer-readable storage medium (or media) having computer-readable program instructions thereon for causing a processor to carry out aspects of the present disclosure. The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium may include a portable computer diskette, a hard disk, a random access memory (“RAM”), a read-only memory (“ROM”), an erasable programmable read-only memory (“EPROM” or Flash memory), a static random access memory (“SRAM”), a hard disk drive (“HDD”), a solid state drive, a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations or block diagrams of methods, apparatuses, systems, algorithms, or computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flow chart diagrams included herein are generally set forth as logical flow chart diagrams. As such, the depicted order and labeled steps are indicative of one embodiment of the presented method. Other steps and methods may be conceived that may be equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Thus, although there have been described particular embodiments of the present invention of new and useful SYSTEMS AND METHODS FOR CAPTURING A THREE-DIMENSIONAL IMAGE, it is not intended that such references be construed as limitations upon the scope of this invention.

What is claimed is:

1. A method, comprising:
positioning a plurality of devices around a calibration subject, wherein
the plurality of devices includes a master device and at least one secondary device, and
each device includes a camera;
calculating, for each secondary device of the at least one secondary devices, a time offset between the master device and the secondary device;
capturing, on each device of the plurality of devices, a first three-dimensional depth frame of the calibration subject, wherein the plurality of devices capture the first three-dimensional depth frames simultaneously based on the time offsets;
calculating a plurality of depths based on the first three-dimensional depth frames;
capturing, on each device of the plurality of devices, a second three-dimensional depth frame of a photography subject, wherein the plurality of devices capture the second three-dimensional depth frames simultaneously based on the time offsets; and
assembling, based on the second three-dimensional depth frames, a three-dimensional data representation of the photography subject.

2. The method of claim 1, further comprising randomly selecting, via a software application, a device of the plurality of devices as the master device.

3. The method of claim 1, further comprising:
receiving, via a user interface of a device of the plurality of devices, a user input designating the device as the master device; and
establishing a data connection between the master device the at least one secondary device.

4. The method of claim 1, wherein calculating the time offset between the master device and the secondary device comprises calculating a time difference between a clock of the master device and the clock of the secondary device.

5. The method of claim 4, wherein the time difference comprises a time interval that the clock of the secondary device is ahead of or behind the clock of the master device.

6. The method of claim 4, wherein calculating the time difference comprises:
at a first time, the master device sending a timestamp request to the secondary device;
the master device storing the first time as a first timestamp;
at a second time, the secondary device determining a second timestamp of the second time in response to the timestamp request;
the secondary device sending the second timestamp to the master device;
at a third time, receiving the second timestamp at the master device;
storing the third time as a third timestamp; and
calculating, at the master device, the time difference based on the first timestamp, the second timestamp, and the third timestamp.

7. The method of claim 6, wherein calculating, at the master device, the time difference based on the first timestamp, the second timestamp, and the third timestamp comprises calculating the time difference according to the equation
$${T}_{d} = {T}_{s} - \frac{{T}_{t} + {T}_{r}}{2}$$
where T_{d} includes the time difference, Tₜ includes the first timestamp, Tₛ includes the second timestamp, and Tᵣ includes the third timestamp.

8. The method of claim 1, wherein:
capturing, on the secondary device of the plurality of devices, the second three-dimensional depth frame of the photography subject comprises the master device sending a capture request to the secondary device;
the capture request comprises a capture time; and
the secondary device capturing its respective second three-dimensional depth frame occurs in response to the capture time arriving.

9. The method of claim 1, wherein:
the first three-dimensional depth frame includes a measured distance from the capturing device to the calibration subject; and
calculating the depth based on the first three-dimensional depth frame comprises calculating a calibrated depth according to the equation
D_{c}=α*(D_{d}−p)²+p
where D_{c} includes the calibrated depth, a includes a depth correction factor, D_{d} includes the measured distance from the capturing device to the calibration subject, and p includes a predetermined distance threshold.

10. The method of claim 9, further comprising calculating the depth correction factor by performing singular value decomposition on a plurality of points in the first three-dimensional depth frame.

11. The method of claim 9, further comprising calculating the depth correction factor by adjusting an angle between two or more surfaces to be closer to 90 degrees.

12. An apparatus, comprising:
a camera;
a processor; and
a computer-readable storage medium storing a software application thereon, wherein in response to the processor executing the software application, the apparatus is configured to
send a timestamp request to a second apparatus at a first time,
receive a response from the second apparatus, the response including a second time, and wherein the response arrived at the apparatus at a third time,
calculate a time offset based on the first time, the second time, and the third time,
send a capture request to the second apparatus, wherein the capture request includes a command for the second apparatus to capture a first three-dimensional depth frame using the camera of the second device at a fourth time that accounts for the time offset, and
capture, at the same time as the capturing of the first three-dimensional depth frame of the second device, a second three-dimensional depth frame using the camera of the device.

13. The apparatus of claim 12, further comprising a transceiver.

14. The apparatus of claim 13, wherein the transceiver comprises at least one of:
a Bluetooth transceiver;
a Wi-Fi transceiver;
a near-field communication (NFC) transceiver;
a cellular data transceiver; or
a wired connection component.

15. The apparatus of claim 13, wherein the apparatus being configured to send the timestamp request to the second apparatus comprises the apparatus being configured to send the timestamp request via the transceiver.

16. The apparatus of claim 13, wherein the apparatus being configured to receive the response from the second apparatus comprises the apparatus being configured to receive the response from the second apparatus via the transceiver.

17. The apparatus of claim 13, wherein the apparatus being configured to send the capture request to the second apparatus comprises the apparatus being configured to send the capture request to the second apparatus via the transceiver.

18. A system for capturing three-dimensional photographs of a photography subject, comprising:
a plurality of devices, including
a master device, and
at least one secondary device,
wherein each device of the plurality of devices includes a camera;
a calibration subject; and
a computing device,
wherein
the master device is operable to calculate, for each of the at least one secondary devices, a time offset between the master device and the secondary device,
the master device and the at least one secondary device are each operable to simultaneously capture a first three-dimensional depth frame of the calibration subject at a first time, wherein the first time is based on the time offsets,
the master device and the at least one secondary device are each operable to simultaneously capture a second three-dimensional depth frame of the photography subject at a second time, wherein the second time is based on time offsets, and
the computing device is operable to assemble, based on the second three-dimensional depth frames, a three-dimensional data representation of the photography subject.

19. The system of claim 18, wherein:
the calibration subject includes a first set of one or more dimensions known by a user of the system; and
the photography subject includes a second set of one or more dimensions unknown by the user of the system.

20. The system of claim 18, wherein the photography subject comprises an item of clothing.
